(19) United States
(12) Patent Application Publication
(10) Pub. No.: US 2008/0177980 A1
(43) Pub. Date: Jul. 24, 2008

(54) INSTRUCTION SET ARCHITECTURE WITH OVERLAPPING FIELDS

(76) Inventor: Daniel Citron, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/626,380

(22) Filed: Jan. 24, 2007

(51) Int. Cl. G06F 9/30; G06F 9/312

(52) U.S. Cl. 712/205; 712/208; 712/E09.03; 712/E09.033

(57) ABSTRACT

A system and corresponding methods that facilitate implementing and decoding variable size instruction fields in a fixed size instruction are provided. In accordance with one aspect of the invention, an instruction has one or more instructions fields, wherein each field is represented by a plurality of bits arranged in a first order. The decoding method comprises fetching the instruction into an instruction register; and determining a mapping foFr a plurality of bits that represent each instruction field, wherein according to the mapping a first set of bits represents a first instruction field, and a second set of bits represents a second instruction field; such that one or more bits in the first set overlap one or more bits in the second set.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to a scheme for overlapping fields of an instruction and, more particularly, to a system and method for improving the functionality of an instruction set architecture (ISA) by way of overlapping bits in multiple instruction fields to increase the size of one or more instruction fields without increasing the size of the instruction itself.

### BACKGROUND

Computers function according to a set of instructions decoded, processed and executed by a controller unit (e.g., a microprocessor). Certain controller units are implemented according to a fixed instruction size. A fixed size instruction, typically, refers to an instruction in an instruction set architecture (ISA) wherein most if not all the instructions have a fixed number of bits.

In such ISAs, the entire length of an instruction to be executed is loaded into an instruction register pursuant to a single fetch operation. The instruction register is a part of the controller unit that stores the instruction, while the instruction is decoded and prepared for execution. FIGS. 1A and 1B illustrate exemplary fixed size load instructions used in a PowerPC ISA typical to most reduced instruction set computer (RISC) processors. FIG. 1A illustrates a D-form instruction and FIG. 1B illustrates an X-form instruction.

A D-form load instruction can be represented by lwz_RT,_D(RA), for example, which when executed causes the processor to load a word from the effective address RA+D and store the word into the register RT. Alternatively, an X-form load instruction can be represented by lwzx_RT,RA,RB, for example, which when executed causes the processor to load a word from the effective address RA+RB and store the word into the register RT.

As shown in FIGS. 1A and 1B, each field RT (bits 6-10), RA (bits 11-15) or RB (bits 16-20) is 5 bits long. Therefore, the ISA can map only 2⁵ or 32 registers. Depending on implementation, it may be preferable to use more than 32 registers to perform a computing function. For that reason, some processing environments are implemented with 2⁶ (64) or 2⁷ (128) or even more registers.

Since the ISA associated with the instructions shown in FIGS. 1A and 1B is implemented to accommodate 5-bit instruction fields in a fixed size instruction, the respective ISA cannot be used in to address more than 32 registers, unless the size of each field is somehow extended. Thus, a disadvantage of an ISA with fixed size instructions is that the fixed nature of the instruction size limits the number of registers that can be addressed. Also, the fixed size of each field limits diversity of the instruction set itself.

Referring to FIG. 1C, to accommodate mapping for additional registers, the instruction fields can be extended by one or more bits. For example, as shown, each of the fields RT, RA and RB can be represented by 6 bits (e.g., bits 6-11, 12-17 and 18-23 respectively) instead of 5 bits. Accordingly, each field in the instruction illustrated in FIG. 1C can map 2⁶ or 64 registers.

Extending the size of a field is not always desirable, because the mapping of registers doubles (e.g., from 32 to 64) every time a single bit is added to an instruction field. Such an implementation is excessive when only a small increase in the number of registers is desirable (e.g., need 40 registers), and insufficient when a greater increase in the number of registers is desirable (e.g., need 80 registers).

Additionally, it is often impractical to change the size of an instruction from one fixed size to another, because most processor architectures are designed to operate based on an exact instruction size. Therefore, changing the instruction size would require designing a new processor chip that operates according to the newly implemented fixed instruction size. Further, an increase in instruction size disadvantageously results in generation of more code and the ultimate use of additional processing resources, such as cache lines, decoding width and storage space.

As such, increasing the size of a fixed size instruction or changing the instruction's format requires a complete redesign of the respective ISA. Redesigning the ISA typically requires changing the hardware architecture of the controller and the associated internal or external interfaces. Such changes are technically expensive to implement and require additional resources that may not be readily available or practical.

An alternative to fixed size ISAs is the use of variable size instructions and a pipeline of instruction registers where each stage of the pipeline performs part of the decoding, preparation or execution. Unfortunately, the hardware and software design for a controller unit that processes variable size instructions is substantially more complicated.

Generally, decoding and processing very long instructions requires that various segments of a long instruction to be loaded into the instruction register by way of several fetch operations, whereas in a fixed size ISA, each instruction is fetched in a single step. Disadvantageously, multiple stage fetching and decoding results in a slower processing speed in the conventional variable size ISAs.

For the above reasons, systems and methods are needed that can solve the above-mentioned problems by way of implementing a method to allow for the use of variable sized fields in a fixed size instruction set.

### SUMMARY

The present disclosure is directed to a system and corresponding methods that facilitate implementing variable size instruction fields in a fixed size instruction, by way of mapping one or more fields to have overlapping bits.

In accordance with one aspect of the invention, a method for decoding an instruction having one or more instruction fields is provided. Each field is represented by a plurality of bits arranged in a first order. The decoding method comprises fetching the instruction into an instruction register; and determining a mapping for a plurality of bits that represent each instruction field.

In accordance with yet another embodiment, a system for decoding a fixed size instruction having one or more fixed size instruction fields is provided. In one embodiment, each field is represented by a plurality of bits arranged in a first order, and the system comprises a logic unit for fetching the entire fixed size instruction into an instruction register; and a logic unit for processing an opcode field of the instruction to determine a mapping of the plurality of bits that represent each of the instruction fields.

In accordance with yet another aspect of the invention, a method for constructing a fixed size instruction having one or more fixed size instruction fields is provided. Each field is represented by a plurality of bits arranged in a first order. The method comprises constructing an opcode field for the instruction to map one or more of the plurality of bits to one or more instruction fields. According to the map a first set of bits represents a first instruction field, and a second set of bits represents a second instruction field, such that one or more bits in the first set overlap with one or more bits in the second set.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIGS. 1A through 1C illustrate exemplary instruction formats utilized in one or more embodiments of the invention.

FIG. 2 illustrates another exemplary instruction format, in accordance with one embodiment, with overlapping fields.

FIGS. 3A and 3B illustrate other exemplary instruction formats, in accordance with one embodiment, with overlapping fields wherein overlapping is not limited to adjacent instruction fields.

FIGS. 4 through 6 illustrate alternative exemplary instruction formats having overlapping bits that may or may not be adjacent.

FIG. 7 is a flow diagram of a method for decoding an instruction according to a mapping for the overlapping bits.

FIGS. 8A and 8B are block diagrams of hardware and software environments in which a system of the present invention may operate, in accordance with one or more embodiments.

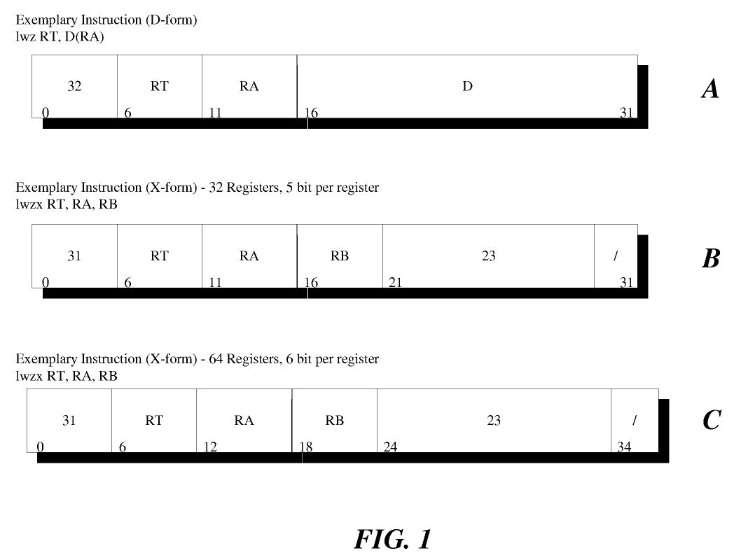

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

The present disclosure is directed to systems and corresponding methods that facilitate constructing and decoding an instruction with overlapping fields.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

In accordance with one aspect of the invention, a microprocessing environment is defined by a set of registers, a timing and control structure, and memory that comprises different cache levels. A set of instructions can be executed in the microprocessing environment. Each instruction is a binary code, for example, that specifies a sequence of microoperations performed by a processor.

Instructions, along with data, are stored in memory. The combination of instructions and data is referred to as instruction code or instruction. To execute the instruction, the processor reads the instruction from memory and places it into an instruction register. The processor then interprets the binary code in the instruction and proceeds to execute it by issuing a sequence of microoperations.

An instruction is divided into parts, with each part having its own interpretation. For example, as provided in more detail below, certain instructions contain three parts: an operation code part, a source data part, and a destination data part. The operation code (i.e., opcode) portion of an instruction specifies the operation to be performed (e.g., load, add, subtract, shift, etc.) and preferably the manner in which one or more bits in the instruction are mapped to represent the instruction's fields.

The source data part of the instruction specifies a location in memory or a register to find the operands (i.e., data) needed to perform the requisite operation. The destination data part of an instruction specifies a location in memory or a register to store the results of the operation. In an exemplary embodiment, the microprocessing environment is implemented using, a processor register and a multi-part instruction as provided in more detail below.

Depending upon the opcode used, the address part of the instruction may contain either an operand (immediate value), a direct address (address of operand in memory), or an indirect address (address of a memory location that contains the actual address of the operand). The effective address (EA) is the address of the operand in memory.

The instruction cycle, in one embodiment, comprises several phases which are continuously repeated. In the initial phase, an instruction is fetched from memory. The processor decodes the fetched instruction. If the instruction has an indirect address, the effective address for the instruction is read from memory. In the final phase, the instruction is executed.

In the following, one or more embodiments of the invention are disclosed, by way of example, as directed to PowerPC instruction set architecture (ISA) typical to most reduced instruction set computer (RISC) processors. It should be noted, however, that alternative embodiments may be implemented using any other instruction set architecture.

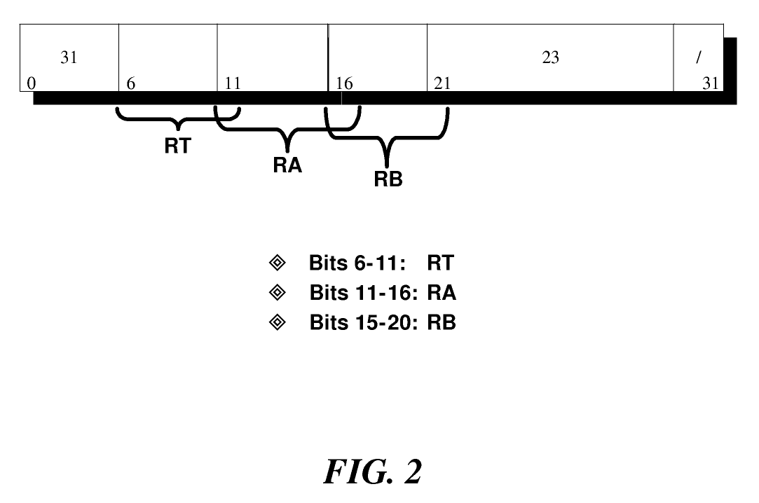

Referring to FIG. 2, according to one embodiment, a fixed size instruction having one or more instruction fields can be constructed such that the length of a first instruction field (e.g., RT) can be increased by way of mapping one or more bits of the first instruction field to overlap with one or more bits of a second instruction field (e.g., RA). In certain embodiments, the instruction fields and the instruction itself may or may not be fixed in size.

As illustrated in the exemplary instruction of FIG. 2, the field representing the RT register originally represented by bits 6-10 (i.e., 5 bits) can be extended by one bit, such that bits 6-11 (i.e., 6 bits) can be used to address one register out of 2⁶ or 64 registers. In a similar manner, RA and RB fields can also be extended from 5 bits to 6 bits. The following represents the mapping of the bits in the exemplary fixed size instruction illustrated in FIG. 2.
Bits 6-11: RT
Bits 11-16: RA
Bits 15-20: RB

Accordingly, by using the above mapping, certain bits that were previously exclusively associated with a specific field are shared (e.g., caused to overlap) with other field. This overlapping virtually increases the effective total length of the instruction (here by 3 bits, for example) without increasing the actual fixed size. Note that, despite that the size of each field has been increased by one bit, the total size of the instruction itself remains fixed at 32 bits, for example.

In other words, in a fixed size instruction such as that illustrated in FIG. 2, wherein each field is represented by a plurality of bits arranged in a first order, one or more of the plurality of bits can be used to map one or more instruction fields. In one embodiment, according to the mapping, a first set of bits (e.g., bits 6-11) represents a first instruction field (e.g., RT), and a second set of bits (e.g., bits 11-16) represents a second instruction field (e.g., RA), such that one or more bits in the first set overlap with one or more bits in the second set.

For example, in FIG. 2, the least significant bit (LSB) of the RT field is mapped to overlap with the most significant bit (MSB) of the RA field as represented by bit 11 of the fixed size instruction. And, the LSB of the RA field is mapped to overlap with the MSB of the RB field as represented by bit 16. According to one embodiment, the adjacent fields in this exemplary instruction share a common bit.

As it is provided in further detail below, it is noteworthy that the mapping of the bits for each field is not limited to bits of adjacent fields nor is the invention limited to scenarios in which the overlapping bits are always adjacent to each other. The mapping, depending on implementation and in different embodiments, can be arranged so that nonadjacent fields share one or more common bits, or nonadjacent bits are mapped to represent a particular bit in an instruction field.

In accordance with one or more embodiments, the mapping is arranged to provide for a bit overlap between a first set and a second set so that the bit overlap between the first set and the second set variably increases the number of bits allocated to an instruction field without reducing the fixed number of bits allocated to another instruction field.

It is noteworthy that the overlapping process, in certain instances, may limit the number of registers that an instruction field can address. For example, the exemplary operation RT=RA+RB may not be represented with the following exemplary instruction:
add RT,RA,RB
where:
   RT=000001
   RA=000010
   RB=100001

Referring to FIG. 2, if the compiler assigns the above register addresses to each instruction field, the MSB of RA (e.g., 0) will coincide with the LSB of RT (e.g., 1). This register assignment, however, will be in conflict with the exemplary mapping requirements illustrated in FIG. 2 and thus will be illegal. Similarly, the MSB of RB (e.g., 1) will coincide with the LSB of RA (e.g., 0) and will be in conflict with the exemplary mapping and thus illegal.

In one embodiment, if a scenario arises where an assignment leads to a conflict, the compiler will determine a solution to overcome the conflict by, for example, either changing the mapping of the instruction fields or implementing the instruction in a different manner to perform the needed operation. For example, the same operation RT=RA+RB can be represented with the following exemplary instruction:
add RT,RA,RB
where:
   RT=000010
   RA=000001
   RB=100001

In the above exemplary instruction, the MSB of RA (e.g., 0) will coincide with the LSB of RT (e.g., also 0). This register assignment is not in conflict with the mapping requirements as both LSB of RT and MSB of RA have the same bit value (i.e., 0). Similarly, the MSB of RB (e.g., 1) will coincide with the LSB of RA (e.g., also 1) and fulfills the conditions imposed by the mapping as both MSB of RB and LSB of RA have the same bit value (i.e., 1).

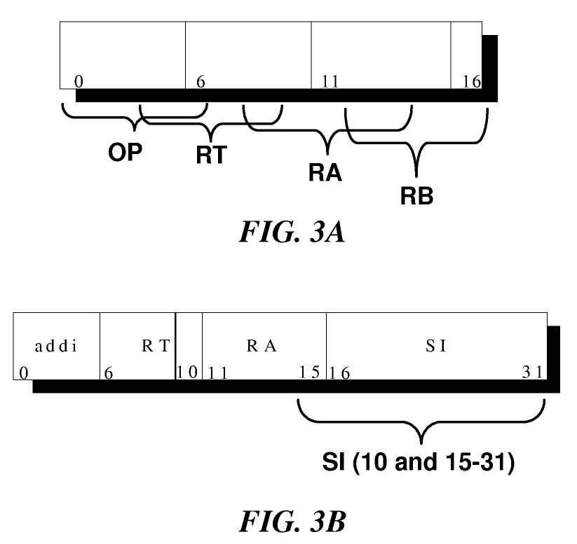

In accordance with another aspect of the invention, the overlapping process can be used to reduce the size of an instruction without losing functionality. For example, referring to FIG. 3A, the size of an exemplary PowerPC instruction can be reduced from 32 bits to 16 bits by way of the illustrated mapping.

As shown in FIG. 3A, the mapping is used to construct an instruction format that can be used to perform, for example, 64 operations because the opcode is represented by 6 bits (i.e., 2⁶=64) in this exemplary embodiment. Further, three 32-bit registers can be mapped as shown, for example, where each field RT, RA and RB is represented by 5 bits (i.e., 2⁵=32).

As illustrated in FIG. 3A, the opcode is overlapped with the first register RT and the three registers RT, RA and RB are mapped using the remaining 11 bits. Advantageously, in this implementation, the compiler can be versatile in its register allocation algorithm. As noted earlier, the overlapping is not limited to adjacent or consecutive fields and depending on implementation overlapping bits may be selected from different parts of the instruction.

For example, referring to FIG. 3A, the MSB of RA in addition to MSB of RT can be mapped to overlap with one or more bits of the opcode, even though RA is not a field adjacent to the opcode. In one embodiment, to accomplish the mapping, the registers can be divided into different classes according to their MSB and LSB. Accordingly, one or more constraints can be defined on the combinations on register classes to properly allocate the needed bits to each field without conflict.

Referring to FIG. 3B, in accordance with another aspect of the invention, the immediate field of an add immediate (“addi”) instruction can overlap with one or more register fields. Therefore, it is noted that the scope of the invention covers not only the overlap of register and opcode fields, but also the overlap of any other field in an instruction, as provided in more detail below.

In an exemplary embodiment, the range of immediates can be enlarged from 16 to 18 bits, for example, to reduce the number of times two instructions would have to be used to store an immediate in a register. As shown in FIG. 3B, the two most significant bits of an 18-bit immediate field are mapped to overlap with the LSB of a source register RA (e.g., bit 15) and the LSB of the destination register RT (e.g., bit 10). Thus, in this example, an 18-bit immediate filed is constructed using bits 10 and 15-31, wherein bits 10 and 15 are overlap implementations.

Since the overlapping process reduces the flexibility of the compiler or programmer, when generating assembly code, in one embodiment, certain known compiler techniques are used to limit representation of one or more instructions to specific registers. Some of such techniques are, for example, implemented in the x86 ISA. In other embodiments, the registers can be divided into classes, in a known manner, as in volatile and nonvolatile function calls.

In a certain embodiment, the overlapping process may be used as an option for a specific code segment. Thus, in such embodiment, two separate modes (e.g., overlapping and non-overlapping modes) are designated. An identifier (e.g., a mode bit) may be used in the processor's control register to distinguish between the two modes. Most modern processors possess such mode bit in their control register. In a preferred embodiment, the mode bit is set or reset in response to determining that an instruction has overlapping fields.

For example, the PowerPC ISA has a Machine State Register (MSR) that provides for several bits that are reserved for future use. One or more of the reserved bits can be implemented as the mode bit. Accordingly, in one embodiment, an instruction constructed with overlapping fields is executed in the appropriate mode according to the status of the mode bit.

In a scenario where a section of the instruction code does not include overlapping bits and another section does (e.g., where non-overlapping instruction code in an existing library is linked with overlapping instruction code), the mode bit is switched to indicate whether the code to be decoded in the overlapping or non-overlapping mode. Therefore, in certain embodiments, the decoding mode is switched back and forth to ensure the proper decoding of instructions with overlapping bits.

It is noteworthy that the scope of the invention should not be construed as limited to a mode bit implemented in a processors control register. Other implementations are possible so that an instruction can comprise an identifier to indicate that the instruction has overlapping bits. Such identifier can be, in one embodiment, a mode identifier bit that is set to identify one or more modes. A first mode, for example, may indicate that an instruction comprises overlapping bits, while the second mode indicates that the instruction does not have overlapping bits.

In certain embodiments, the identifier bit may be included in the instruction's opcode. In a preferred embodiment, the opcode also includes information about which bits are overlapped and how each bit is mapped to each instruction field. In the following, several examples are provided to enable a person of ordinary skill in the art to construct and decode an instruction in accordance with one aspect of the invention. It is noteworthy, however, that the following is provided for the purpose of example only and the scope of the invention should not be limited to these particular exemplary embodiments.

### EXAMPLE 1

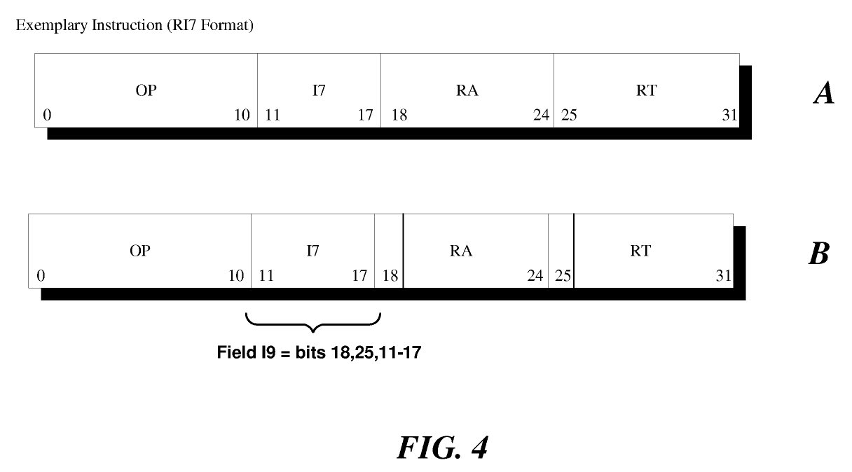

Referring to FIG. 4A, in a cell processor with 128 registers (i.e., 7-bits per register), an RI7-Form instruction is implemented with the following fields: opcode, 7-bit immediate field, RA register and RT register. Referring to FIG. 4B, in accordance with on aspect of the invention, the I7 field can be widened to 9 bits by mapping bits 18 and 25 to represent the I7 field in addition to bits 11-17. This mapping enlarges the range of the immediate field and limits RA and RT. RA can be one of the registers R64-R127, if the first bit of the I9 field is 1; and RT can be one of the registers R64-R127, if the first bit of the I9 field is 1, for example.

### EXAMPLE 2

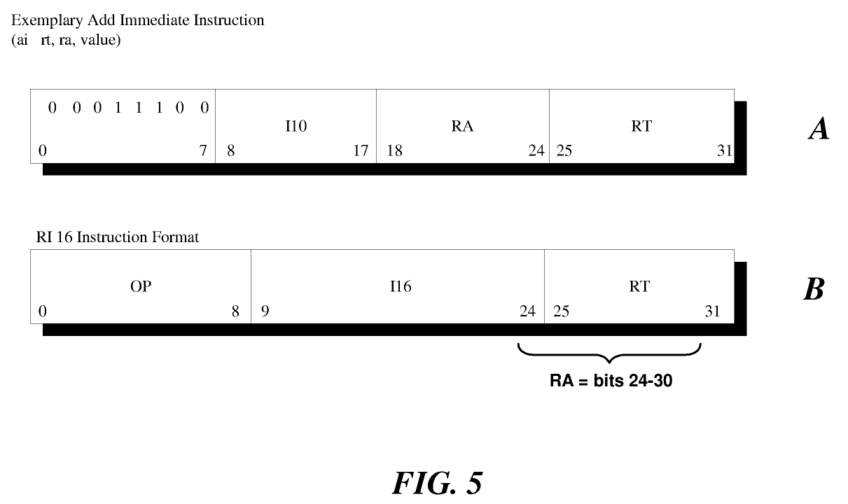

Referring to FIGS. 5A and 5B, the range of an add-immediate instruction for an exemplary operation such as RT=RA+I10 can be extended in a cell processor by adding a 16-bit immediate to a register. In one embodiment, a larger value is written into a register and then added by way of implementing an extra instruction. To accomplish this, a RI16 form instruction is implemented with overlap fields for an operation RT=RA+I16. In this implementation, the possibilities of RA are limited to two registers, for example.

### EXAMPLE 3

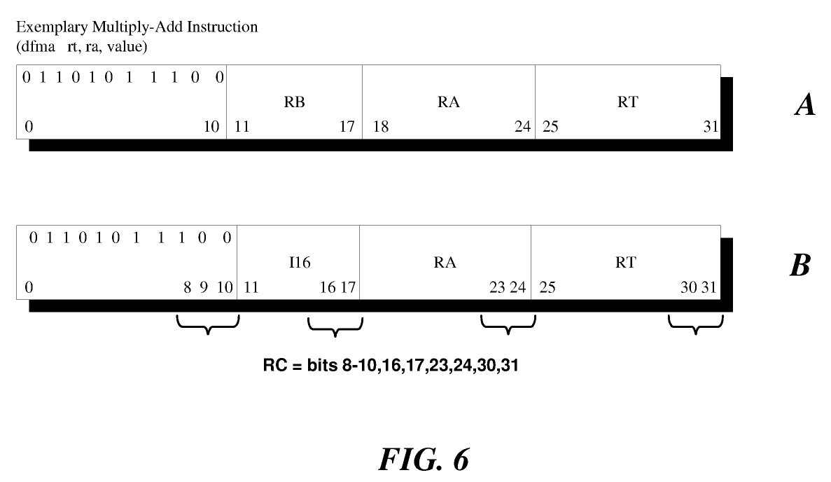

Referring to FIGS. 6A and 6B, in accordance with one aspect of the invention, a 4-register multiply-add instruction may be implemented in a cell processor. FIG. 6A illustrates a multiply-add instruction in which a first value in RA is multiplied by a second value in RB; the multiplication result is then added to a third value in RT. The final result of the multiply-add operation is then stored in RT (i.e., RT=RA*RB+RT).

Disadvantageously, after the above multiply-add operation is performed, the third value originally stored in the RT register is overwritten with the final result. If it is desirable to preserve the third value, in one embodiment, a 4-register instruction can be implemented by way of bit overlapping. Referring to FIG. 6B, for example, a 4-register multiply-add instruction having fields RT, RA, RB and RC can be implemented such that RT=RA*RB+RC. As shown, the RC field can be mapped to overlap any bit in the range of zero to 31 of the instruction (e.g., bits 8-10,16,17,23,24,30,31). In this manner, the value stored in the RC register can be preserved, rather than being overwritten.

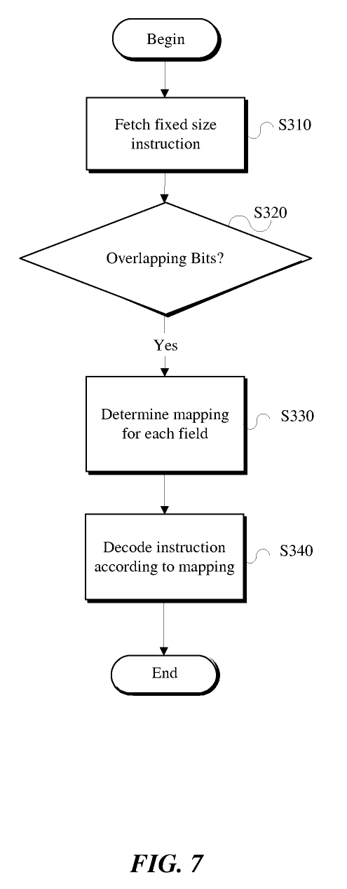

Referring to FIG. 7, an exemplary method for decoding an instruction constructed by the above-noted overlapping process is provided. In accordance with one embodiment, when the processor fetches a fixed size instruction, preferably the entire length of the instruction is loaded in an instruction register for decoding (S310). The processor then determines whether the instruction includes overlapping bits (S320). Depending on implementation, either a mode bit is set in the processor or one or more bits in the opcode or other field in the instruction are set to indicate that the instruction includes overlapping bits.

In response to determining that the instruction includes overlapping bits, the processor determines the mapping for each field (S330). Depending on implementation, the mapping information in a preferred embodiment is included in the opcode field, for example. It is noteworthy, however, that the mapping information can be included in any other instruction field or provided to the processor in any other manner and in certain embodiments independently from the content of the instruction itself. Once the mapping for each instruction field is determined, the instruction is decoded according to the mapping (S340).

One or more embodiments are disclosed, by way of example, as applicable to an instruction in a fixed sized ISA (e.g., PowerPC) where at least two fields in the instruction share one or more common bits. It is noteworthy, however, that the principal concepts and teachings of the invention can be equally applied with some adjustments, if needed, to other types of ISAs that have different instruction formats or that are implemented with variable instruction sizes, without detracting from the scope of the invention.

In different embodiments, the invention can be implemented either entirely in the form of hardware or entirely in the form of software, or a combination of both hardware and software elements. For example, the microprocessing environment disclosed above may comprise a controlled computing system environment that can be presented largely in terms of hardware components and software code executed to perform processes that achieve the results contemplated by the system of the present invention.

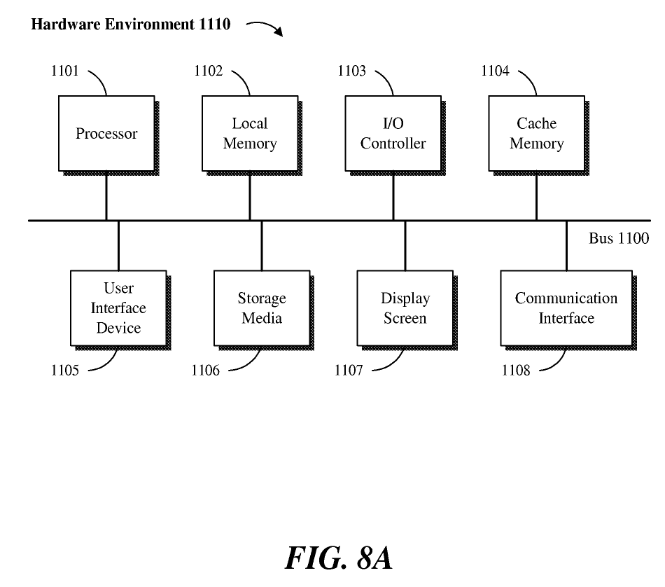

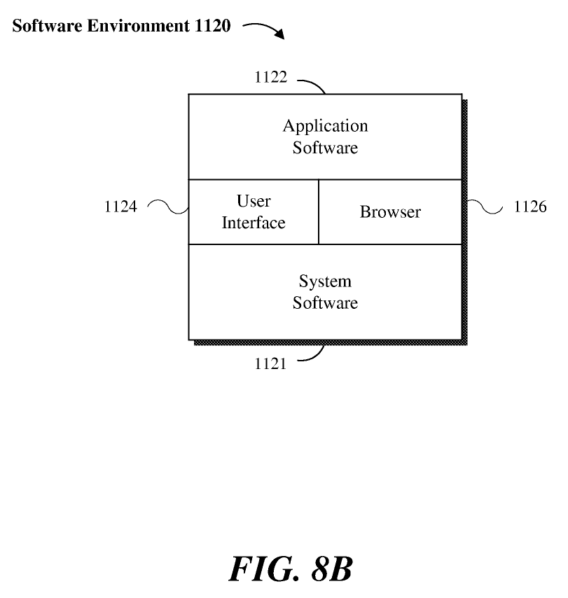

Referring to FIGS. 8A and 8B, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In a preferred embodiment, compiler or other software is implemented as application software 1122 executed on one or more hardware environments to arrange for mapping of overlapped bits in an instruction or decoding an instruction having overlapping fields, as provided earlier. Application software 1122 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIG. 8A, an embodiment of the application software 1122 can be implemented as computer software in the form of computer readable code executed on a data processing system such as hardware environment 1110 that comprises a processor 1101 coupled to one or more memory elements by way of a system bus 1100. The memory elements, for example, can comprise local memory 1102, storage media 1106 and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 8B, application software 1122 can comprise one or more computer programs that are executed on top of system software 1121 after being loaded from storage media 1106 into local memory 1102. In a client-server architecture, application software 1122 may comprise client software and server software. For example, in one embodiment of the invention, client software is executed on computing system 100 and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for decoding an instruction having one or more instruction fields, wherein each field is represented by a plurality of bits arranged in a first order, the method comprising:
fetching the instruction into an instruction register; and
determining a mapping for a plurality of bits that represent each instruction field,
wherein according to the mapping:
a first set of bits represents a first instruction field, and
a second set of bits represents a second instruction field,
such that one or more bits in the first set overlap with one or more bits in the second set.

2. The method of claim 1, wherein the overlapping bits are not adjacent to each other.

3. The method of claim 1, wherein the instruction is a fixed size instruction.

4. The method of claim 1, wherein at least one of the instruction fields is a fixed size instruction field.

5. The method of claim 1, wherein the first field comprises an opcode.

6. The method of claim 1, wherein bit overlap between the first set and the second set does not reduce number of bits allocated to each instruction field.

7. The method of claim 1, wherein bit overlap between the first set and the second set allows for number of bits allocated to each instruction field to be variably adjusted depending on number of overlapping bits.

8. The method of claim 1, wherein the instruction comprises an identifier indicating that the instruction comprises overlapping bits.

9. The method of claim 1, wherein the instruction comprises a mode identifier bit that is set to identify a first mode and a second mode, wherein:
the first mode indicates that the instruction comprises overlapping bits, and
the second mode indicates that the instruction does not comprise overlapping bits.

10. The method of claim 9 further comprising:
examining the mode identifier bit;
switching to a first decoding mode in response to detecting the first mode; and
switching to a second decoding mode in response to detecting the second mode.

11. A system for decoding a fixed size instruction having one or more fixed size instruction fields, wherein each field is represented by a plurality of bits arranged in a first order, the system comprising:
a logic unit for fetching the entire fixed size instruction into an instruction register; and
a logic unit for processing an opcode field of the instruction to determine a mapping of the plurality of bits that represent each of the instruction fields,
wherein according to the mapping:
a first set of bits represents a first instruction field, and
a second set of bits represents a second instruction field,
such that one or more bits in the first set overlap with one or more bits in the second set.

12. The system of claim 11, wherein the instruction comprises a mode identifier bit that is set to identify a first mode and a second mode, wherein:
the first mode indicates that the instruction comprises overlapping bits, and
the second mode indicates that the instruction does not comprise overlapping bits.

13. The system of claim 12 further comprising:
a logic unit for examining the mode identifier bit, and switching to a first decoding mode in response to detecting the first mode, and switching to a second decoding mode in response to detecting the second mode.

14. The system of claim 11, wherein the overlapping bits are not adjacent to each other with respect to the first order of bits in the fixed size instruction.

15. A method for constructing a fixed size instruction having one or more fixed size instruction fields, wherein each field is represented by a plurality of bits arranged in a first order, the method comprising:
constructing an opcode field for the instruction to map one or more of the plurality of bits to one or more instruction fields, wherein according to the map:
a first set of bits represents a first instruction field, and
a second set of bits represents a second instruction field,
such that one or more bits in the first set overlap with one or more bits in the second set.

16. The method of claim 15, wherein the overlapping bits are not adjacent to each other with respect to the first order of bits in the fixed size instruction.

17. The method of claim 15, wherein bit overlap between the first set and the second set does not reduce fixed number of bits allocated to each instruction field.

18. The method of claim 15, wherein bit overlap between the first set and the second set variably increases the number of bits allocated to each instruction field.

19. The method of claim 15, wherein the instruction comprises an identifier indicating that the instruction comprises overlapping bits.

20. The method of claim 15, wherein the instruction comprises a mode identifier bit that is set to identify a first mode and a second mode, wherein:
the first mode indicates that the instruction comprises overlapping bits, and
the second mode indicates that the instruction does not comprise overlapping bits.
